(19) United States
(12) Patent Application Publication
(10) Pub. No.: US 2019/0051142 A1
(43) Pub. Date: Feb. 14, 2019

(54) LAW ENFORCEMENT ASSISTANCE METHOD AND APPARATUS

(71) Applicant: Intel Corporation, Santa Clara, CA (US)

(72) Inventor: Amy Wiles, Hillsboro, OR (US)

(21) Appl. No.: 15/816,894

(22) Filed: Nov. 17, 2017

(51) Int. Cl. G08B 25/10; G08G 1/017; G08G 1/00; H04L 29/08

(52) U.S. Cl. CPC G08B 25/10; G08G 1/017; G08G 1/205; G01S 19/01; H04W 4/04; G08G 1/22; B60W 2550/408; H04L 67/12

(57) ABSTRACT

Apparatuses, methods and storage media associated with law enforcement assistance in the context of computer-assisted or autonomous driving vehicles are disclosed herein. In embodiments, an apparatus for computer-assisted or autonomous driving may include a communication interface to receive a law enforcement related message having description of a vehicle of interest to a law enforcement agency, and a sensor interface to receive sensor data associated with vehicles around a host vehicle on which the apparatus is disposed. Further, the apparatus may include a law enforcement assistance unit coupled to the communication interface and the sensor interface to determine whether one of the vehicles around the host vehicle is the vehicle of interest, based at the least in part on the description of the vehicle of interest in the law enforcement related message and the received sensor data. Other embodiments may be described and claimed.

### TECHNICAL FIELD

The present disclosure relates to the field of computer-assisted or autonomous driving, in particular, to law enforcement assistance methods, apparatuses, and storage medium for computer-assisted or autonomous driving vehicles.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Law Enforcement Agencies often require the assistance of the public in solving a crime. For examples, Law Enforcement Agencies often require the assistance of the public in identifying and/or locating a person and/or a vehicle, such as in the case of Amber Alerts in the United States, where law enforcement related messages are issued to seek public assistance in locating persons and/or vehicles potentially associated with child abduction situations.

With advances in integrated circuits and computing technology, increasingly more and more computer-assisted vehicles are on road, and fully autonomous driving vehicles are just around the corner. These computer-assisted or autonomous driving vehicles are expected to be packed with highly capable sensors and computing power.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an environment for incorporating and using the law enforcement assistance technology of the present disclosure, in accordance with various embodiments.

FIG. 2 illustrates a block diagram view of an example computer-assisted or autonomous driving system, in accordance with various embodiments.

FIG. 3 illustrates an example process for law enforcement assistance, in accordance with various embodiments.

FIG. 4 illustrates an example computer system, suitable for use to practice the present disclosure (or aspects thereof), in accordance with various embodiments.

FIG. 5 illustrates an example storage medium with instructions configured to enable a computer-assisted or autonomous driving system to practice the present disclosure, in accordance with various embodiments.

### DETAILED DESCRIPTION

Apparatuses, methods and storage media associated with law enforcement assistance in the context of computer-assisted or autonomous driving vehicles are disclosed herein. In embodiments, an apparatus for computer-assisted or autonomous driving may include a communication interface to receive a law enforcement related message having description of a vehicle of interest to a law enforcement agency, and a sensor interface to receive sensor data associated with vehicles around a host vehicle on which the apparatus is disposed. Further, the apparatus may include a law enforcement assistance unit coupled to the communication interface and the sensor interface to determine whether one of the vehicles around the host vehicle is the vehicle of interest, based at the least in part on the description of the vehicle of interest in the law enforcement related message and the received sensor data.

In embodiments, the law enforcement assistance unit may include a law enforcement interaction component to process the received law enforcement related message to extract the description of the vehicle of interest to the law enforcement agency. The description of the vehicle of interest may include one or more of a license plate number of the vehicle of interest, a maker of the vehicle of interest, a model of the vehicle of interest, a year made of the vehicle of interest, or a color of the vehicle of interest. In embodiments, the sensor data associated with vehicles around the host vehicle may include images of the vehicles around the host vehicle, and the law enforcement assistance unit may include an analysis component to process the images to extract one or more of license plate numbers of the vehicles around the host vehicle, makers of the vehicles around the host vehicle, models of the vehicle around the host vehicle, years made of the vehicles around the host vehicle, or colors of the vehicles around the host vehicle.

In embodiments, the apparatus may be a computer-assisted or autonomous driving system disposed in the vehicle, or the vehicle itself, which may be a computer-assisted or autonomous driving vehicle. In embodiments, the vehicle may be an electric vehicle having a battery, such as, a Li-ion battery, or a combustion engine vehicle.

In the description to follow, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (ASIC), an electronic circuit, a programmable combinational logic circuit (e.g., field programmable gate arrays (FPGA)), a processor (shared, dedicated, or group) and/or memory (shared, dedicated, or group) that execute one or more software or firmware programs generated from a plurality of programming instructions and/or other suitable components that provide the described functionality.

As used herein, the terms “computer-assisted driving” and “semi-autonomous driving” are synonymous to each other. In particular, “semi-autonomous” does not mean exactly 50% computer-assisted, the percentage of computer assisted automation may be anywhere from fraction of a % to almost 100%.

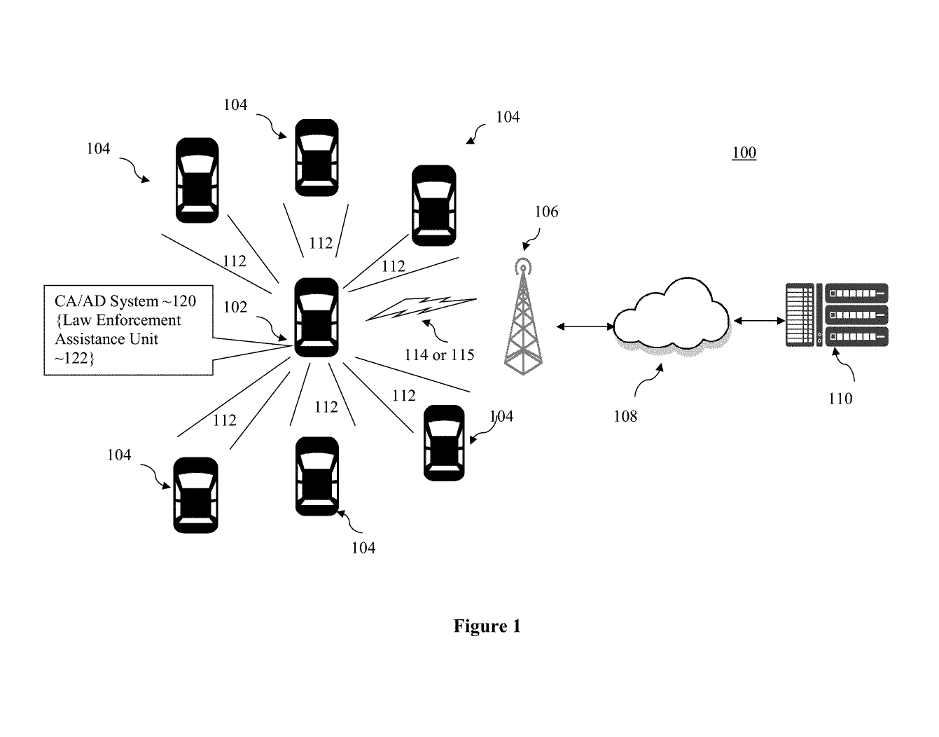

Referring now FIG. 1, an environment for incorporating and using the law enforcement assistance technology of the present disclosure, in accordance with various embodiments, is shown. As illustrated, in embodiments, example environment 100 may include computer-assisted or autonomous driving (CA/AD) vehicle 102. CA/AD vehicle 102 may include a CA/AD system 120 having law enforcement assistance unit (LEAU) 122. LEAU 122 may be configured to receive a law enforcement related message 114 transmitted/broadcast by e.g., servers 110. Law enforcement related message 114 may be a message from or on behalf of a law enforcement agency requesting for public assistance in the identification and/or location of a person and/or a vehicle, e.g. an Amber Alert message in the United States for a child abduction situation. Other examples may include law enforcement messages indicating a law enforcement agency looking for a person or vehicle of a particular description, such as a police all-points bulletin to the field personnel/officers. In embodiments, law enforcement related message 114 may include description of a vehicle of interest to the law enforcement agency.

In embodiments, vehicle 102 may be configured with a number of sensors (not shown) to collect sensor data 112 associated with vehicles 104 around itself. LEAU 122 of CA/AD system 120 on board of vehicle 120, in response to receipt of law enforcement related message, may determine whether one of the vehicles 104 around itself is the vehicle of interest. In embodiments, LEAU 122 may make the determination based at the least in part on the description of the vehicle of interest in the law enforcement related message and the received sensor data. In embodiments, vehicle 102 may be an electric vehicle having a battery, such as, a Li-ion battery, or a combustion engine vehicle.

In embodiments, law enforcement related message 114 may be transmitted/broadcast by e.g., servers 110 associated with a law enforcement agency, such as a local police or sheriff department, the Federal Bureau of Investigation (FBI), the Bureau of Alcohol, Tobacco and Firearm (ATF), and so forth. In alternate embodiments, law enforcement related message 114 may be transmitted/broadcast by e.g., servers 110 on behalf of the law enforcement agency. Examples of such servers may include but are not limited to servers of public or private broadcasting or media organizations. Examples of public or private broadcasting or media organizations may include, but are not limited to, television (TV) broadcasters (such as local TV stations, public broadcasting service (PBS) stations), radio broadcasters (such as local radio stations, national public radio (NPR) stations), and social networks (such as Facebook).

In embodiments, law enforcement related message 114 may be transmitted/broadcast over the airwave or via one or more private and/or public wired and/or wireless networks 108, including the Internet, the network of a cellular service provider, and so forth, and ultimately through a wireless signal repeater or base station on transmission tower 106 near vehicle 102. It is understood that transmission tower 106 may be different towers at different times/locations, as vehicle 102 en route to its destination.

In embodiments, the description of the vehicle of interest in law enforcement relate message 114 may include one or more of a license plate number of the vehicle of interest, a maker of the vehicle of interest, a model of the vehicle of interest, a year made of the vehicle of interest, or a color of the vehicle of interest. In embodiments, the sensor data associated with vehicles 104 around vehicle 102 being collected may include photographic or radar images of vehicles 104 around vehicle 102. For these embodiments, LEAU 120 may extract the license plate number of the vehicle of interest, the maker of the vehicle of interest, the model of the vehicle of interest, the year made of the vehicle of interest, and/or the color of the vehicle of interest from law enforcement related message 114. Similarly, LEAU 120 may extract the license plate numbers of vehicle 104, and/or determine the makers of vehicles 104, the models of vehicles 104, the years made of vehicles 104, or the colors of vehicles 104 using the photographic or radar images of vehicles 104 around vehicle 102. On extraction/determination of these information, LEAU 120 may compare the extracted license plate number of the vehicle of interest, the maker of the vehicle of interest, the model of the vehicle of interest, the year made of the vehicle of interest, and/or the color of the vehicle of interest with the extracted/determined license plate numbers of vehicle 104, the makers of vehicles 104, the models of vehicles 104, the years made of vehicles 104, and/or the colors of vehicles 104, to determine whether one of vehicles 104 around vehicle 102 is the vehicle of interest.

In embodiments, on determination that one of vehicles 104 around vehicle 102 is the vehicle of interest or with strong likelihood the vehicle of interest, LEAU 120 may transmit message 115 to report the determination. In embodiments, report message 115 may include the current location of vehicle 102, date, time, direction of travel etc. In embodiments, report message 115 may include sensor data (e.g., an image) of the vehicle thought to be the vehicle of interest. In embodiments, report message 115 may further include a score or a confidence level that the reported vehicle is or likely to be the vehicle of interest. In embodiments, report message 115 may include contact information of the owner, driver and/or passenger of vehicle 102. Contact information may include phone number, email address and so forth, of the owner, driver and/or passenger of vehicle 102.

In embodiments, report message 115 may be send to the law enforcement agency directly or to a public/private organization, which may or may not be the public/private organization who transmitted/broadcast law enforcement related message 114 for the law enforcement agency. In embodiments, the means for reporting, e.g., a telephone number for verbal or text message reporting, an email address for email reporting, may be included with law enforcement relate message 114 transmitted/broadcast, and similar to the description of the vehicle of interest, LEAU 120 may extract the means for reporting from the law enforcement relate message 114 transmitted/broadcast. In other embodiments, LEAU 120 may be pre-configured with, or configured to dynamically obtain the law enforcement agency contact information (e.g., from a public directory available via the Internet). In still other embodiments, LEAU 120 may simply report the determination to a standard emergency number of the current jurisdiction, e.g., 911 in the United States.

Thus, with the law enforcement assistance technology of the present disclosure, computer-assisted or autonomous driving vehicles could provide much greater assistance to law enforcement agencies in locating a person or a vehicle of interest. These and other aspects of the law enforcement assistance technology in the context of CA/AD, will be further described below with references to the remaining figures.

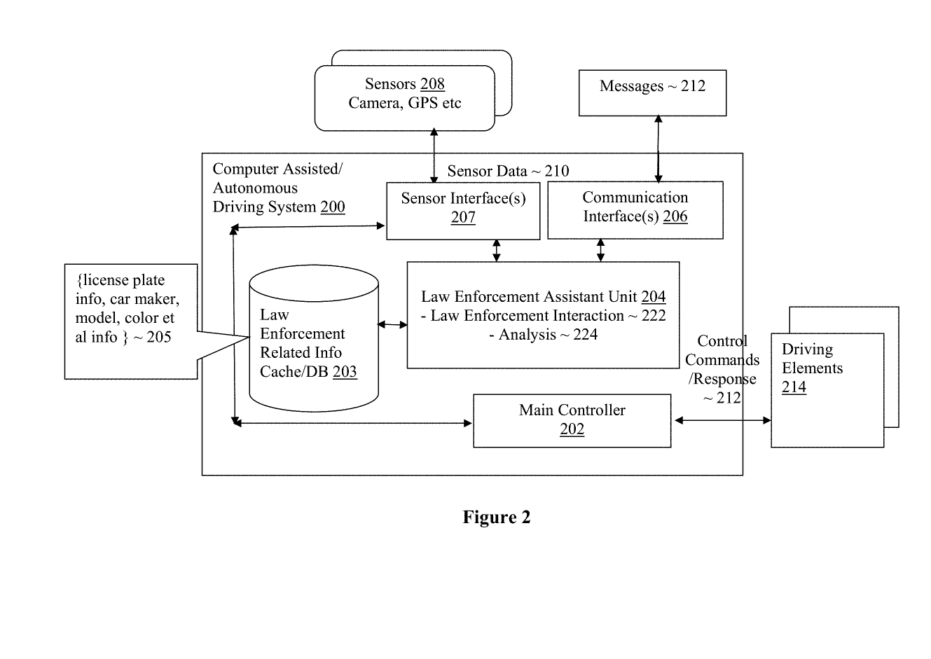

Referring now to FIG. 2, wherein a block diagram view of an example CA/AD system, in accordance with various embodiments, is shown. As illustrated, CA/AD system 200 may include one or more communication interfaces 206, one or more sensor interfaces 207, law enforcement assistance unit 204, law enforcement related information cache/database 203, and main controller 202 coupled with each other as shown.

In embodiments, one of the one or more communication interfaces 206 may be configured to receive a message 212, which may be earlier described law enforcement related message 114 of FIG. 1, as vehicle 102 is en route to a destination. In embodiments, one or more sensor interfaces 207 may be configured to receive various sensor data 210, in particular, sensor data about surrounding vehicles, from sensors 208 disposed on vehicle 102, while vehicle 102 is en route to a destination. In embodiments, sensor data 210 may comprise camera data, radar data, GPS data, and so forth, e.g., camera data, radar data, GPS data, and so forth, collected respectively by a camera, a radar sensor, a GPS sensor 208, and so forth, disposed in CA/AD vehicle 102. In embodiments, one of the one or more communication interfaces 206 may be configured to send a message 212 to report a determination that one of vehicles 104 around vehicle 102 is or likely to be the vehicle of interest.

In embodiments, sensors 208 may be operated continuously to collect the relevant information about the surrounding vehicles 104, in the event that public assistance in locating a vehicle of interest is needed, while en route to the destination. In embodiments, sensors 208 may be operated to collect the relevant information about the surrounding vehicles 104 to provide assistance to law enforcement, only in response to the receipt of a law enforcement related message 212 requesting public assistance, and for a predetermined amount of time thereafter, even if the vehicle is still en route, and destination has not been reached yet.

In embodiments, one or more communication interfaces 206 may include a communication interface, such as 3G/4G, or LTE, to receive and send messages 212 from and to the law enforcement agency or organizations that act on behalf of the law enforcement agency. In embodiments, one or more sensor interfaces 207 may include an input/output (I/O) or bus interface, such as a I² bus, an Integrated Drive Electronic (IDE) bus, a Serial Advanced Technology Attachment (SATA) bus, a Peripheral Component Interconnect (PCI) bus, a Universal Serial Bus (USB), a Near Field Communication (NFC) interface, a Bluetooth® interface, WiFi, and so forth, for receiving sensor data 210 from sensors 208.

Still referring to FIG. 2, in embodiments, communication interface(s) 206, on receipt of message 212, may forward message 212 to LEAU 204. Similarly, sensor interface(s) 207, on receipt of sensor data 210, may forward sensor data 210 to LEAU 204 and/or main controller 202. In alternate embodiments, some sensor data 210 may be provided to LEAU 204 directly (not shown) without going through sensor interface(s) 207.

As described earlier, LEAU 204, on receipt of message 212, may process the message and determine that it is a law enforcement related message. Specifically, LEAU 204 may be configured to determine that it is a law enforcement related message requesting for public assistance in the identification or location of a person or vehicle. In embodiments, on determination of such request for public assistance law enforcement related message, LEAU 204 may process message 212 to extract the description of the vehicle of interest. For the illustrated embodiments, LEAU 204 may include a law enforcement interaction unit 222 configured to perform such recognition and information extraction. Law enforcement interaction unit 222 may be configured to perform such processing/extraction, using any audio/speech and/or text recognition techniques known in the art.

LEAU 204, on receipt of sensor data 210, may process the sensor data, e.g., image data to determine extract the license plate numbers, the makers, the models, the years made, and/or the colors of vehicles 104 around vehicle 102. For the illustrated embodiments, LEAU 204 may include an analysis unit 224 to perform such processing and data extraction. Similarly analysis unit 224 may perform such processing and data extraction, using any image and/or signal processing techniques known in the art.

In embodiments, cache/database 203 may be configured to store various law enforcement assistance related information. In embodiments, cache/database 203 may be configured to store information 205 about license plates of various jurisdictions, their colors, graphics, their alphanumeric system, and so forth. In embodiments, cache/database 203 may be configured to store information about license plates of various jurisdictions based on the current location of vehicle 102. For example, cache/database 203 may be configured to store information about license plates of west coast jurisdictions of the United States when vehicle 102 is in one of the western states of the United States, and store information about license plates of east coast jurisdictions of the United States when vehicle 102 is in one of the eastern states of the United States. In other embodiments, cache/database 203 may be configured to store information 205 about various makers, models, colors, years made of various vehicles, including e.g., reference images of vehicles of various makes, models colors and years made.

In embodiments, analysis unit 224 may be configured to access the law enforcement related information 205 in cache/database 203 when making its determination whether one of vehicles 104 is or likely to be the vehicle of interest. In alternate embodiments, analysis unit 224 may be configured to access a remote database (not shown) with such information, via communication interface 206, instead.

In embodiments, analysis unit 224 may employ any one of a number weighting algorithms in weighing the various factors being considered, e.g., make, model, color, year made of a vehicle, when determining whether one of vehicles 104 is or likely to be the vehicle of interest, when analysis unit 224 is not able to make an exact match of the license plate (e.g., when the license plate has been switched). In embodiments, analysis unit 224 may generate a score or a confidence level for each vehicle 104 to quantitatively reflect whether the vehicle is likely to be the vehicle of interest. Further, for these embodiments, analysis unit 224 may be configured with any scoring or confidence threshold, above which, before a vehicle 104 is considered to be likely the vehicle of interest, and report the determination.

In embodiments, main controller 202 may be configured to receive sensor data 210, process sensor data 210, and based at least in part on the results of the processing, issue control commands 212 to driving elements 214 of CA/AD vehicle 102 (e.g., engine, brake, and so forth) to move/drive CA/AD vehicle 102.

In embodiments, LEAU 204 and main controller 202 may be implemented in hardware, e.g., ASIC, or programmable combinational logic circuit (e.g., (FPGA)), or software (to be executed by a processor and memory arrangement), or combination thereof. For software implementations, in some embodiments, LEAU 204 and main controller 202 may share a common execution environment provided by the same processor and memory arrangement. In alternate embodiments, LEAU 204 and main controller 202 may be implemented to operate in different execution environments, e.g., LEAU 204 to operate in a general execution environment for applications, and main controller 202 to operate in a separate trusted/secured execution environment, that is separate, isolated and protected from the general execution environment for applications.

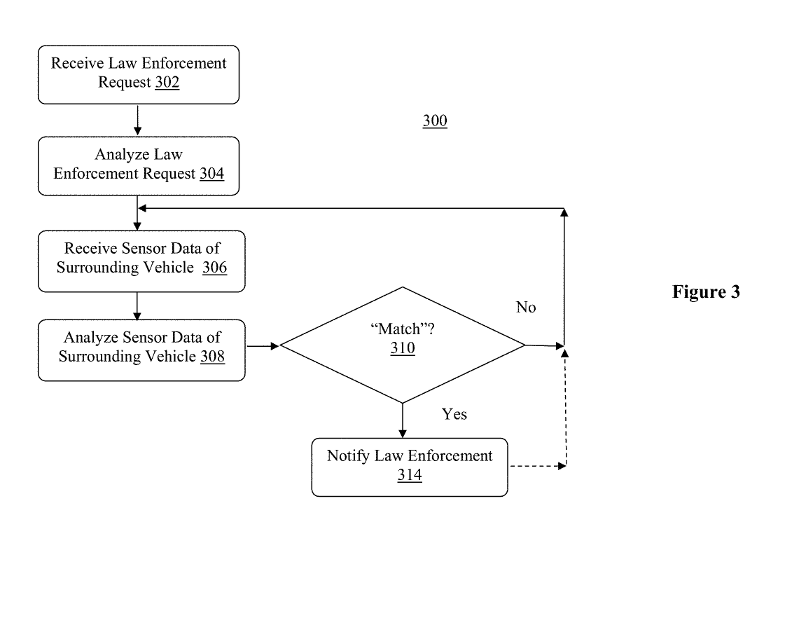

Referring now to FIG. 3, wherein an example process for law enforcement assistance, in accordance with various embodiments, is shown. As illustrated, process 300 for law enforcement assistance may include operations performed in blocks 302-314. The operations may be performed by e.g., CA/AD system 200 of FIG. 2. In alternate embodiments, process 300 for law enforcement assistance may include more or less operations, or have some of the operations performed in different order.

Process 300 may start at block 302. At block 302, a law enforcement related message requesting for public assistance, e.g. an Amber Alert in United States for a child abduction situation, may be received. At block 304, the law enforcement related message requesting for public assistance may be analyzed, e.g., to determine a law enforcement is requesting for public assistance in identifying or locating a person or vehicle. Further the law enforcement related message may be analyzed to extract relevant information, e.g., description of a vehicle interest, such as, its license plate, make, model, color and/or or year, and/or reporting information, such as telephone number, or email address of the law enforcement agency.

At block 306, sensor data, such as image data, of surrounding vehicles may be received. At block 308, the sensor data may be analyzed to determine e.g., the license plates, the makers, the models, the colors and/or or the years made of the surrounding vehicles. As described earlier, the analysis may be performed using reference images of various vehicles, and/or license plate information stored in a cache/database.

At block 310, a determination may be made on whether any of the surrounding vehicles is or likely to be the vehicle of interest, using the description information of the vehicle of interest extracted from the law enforcement related message, and the sensor data collected for the surrounding vehicles. As described earlier, various weighting algorithms may be employed to weigh the various factors and generate a score or confidence level for whether a particular vehicle is or likely to be the vehicle of interest.

If a result of the determination is negative, process 300 may return to block 306 and continue therefrom, as earlier described. However, if a result of the determination is affirmative, at block 310, a message may be transmitted to report the sighting to the law enforcement agency (or to a private/public organization who issued the law enforcement related message on behalf of the law enforcement agency). As described earlier, the reporting message may include the sensor data (e.g., an image) of the vehicle sighted, the sighting (GPS) location, and/or a score or confidence level that the particular vehicle is the vehicle of interest. On reporting, process 300 may terminate. In alternate embodiments, process 300 may return to block 306 and continue therefrom, if the score or confidence level that the reported vehicle is the vehicle of interest is not overwhelmingly high.

What constitute overwhelmingly high score or confidence level may be application/implementation dependent. In embodiments, the threshold level above which a report is made, and the threshold level above which the score or confidence level is considered overwhelmingly high may be configurable by an administrator or a user of CA/AD system 200.

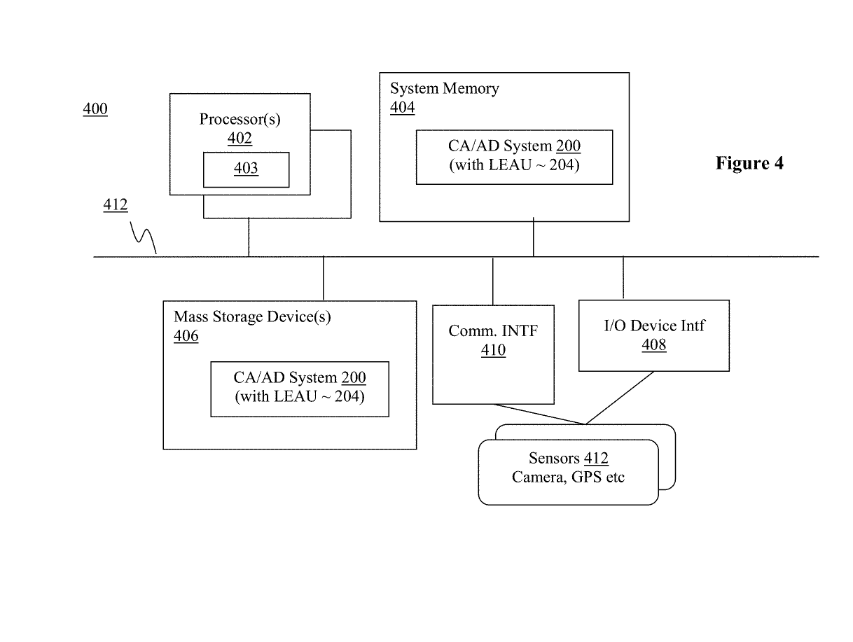

Referring now to FIG. 4, wherein a block diagram of a computer device suitable for practice aspects of the present disclosure, in accordance with various embodiments, is illustrated. As shown, in embodiments, computer device 400 may include one or more processors 402 and system memory 404. Each processor 402 may include one or more processor cores. In embodiments, one or more processors 402 may include one or more hardware accelerators (such as, FPGA). System memory 404 may include any known volatile or non-volatile memory. Additionally, computer device 400 may include mass storage device(s) 406 (such as solid state drives), input/output device interface 408 (to interface with e.g., sensors) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage device(s) 406 may be employed to store a working copy and a permanent copy of the executable code of the programming instructions implementing the operations described earlier, e.g., but are not limited to, operations associated with CA/AD system 200 of FIG. 2, in particular, operation related to LEAU 204 of FIG. 2. The programming instructions may comprise assembler instructions supported by processor(s) 402 or high-level languages, such as, for example, C, that can be compiled into such instructions. In embodiments, some of the functions performed by LEAU 204 may be implemented with hardware processor 403 instead.

The permanent copy of the executable code of the programming instructions and/or the bit streams to configure hardware accelerator 403 may be placed into permanent mass storage device(s) 406 or hardware accelerator 403 in the factory, or in the field, through, for example, a distribution medium (not shown), such as a compact disc (CD), or through communication interface 410 (from a distribution server (not shown)).

Except for the use of computer system 400 to host CA/AD system 200 (including LEAU 204, the constitutions of the elements 410-412 are otherwise known, and accordingly will not be further described.

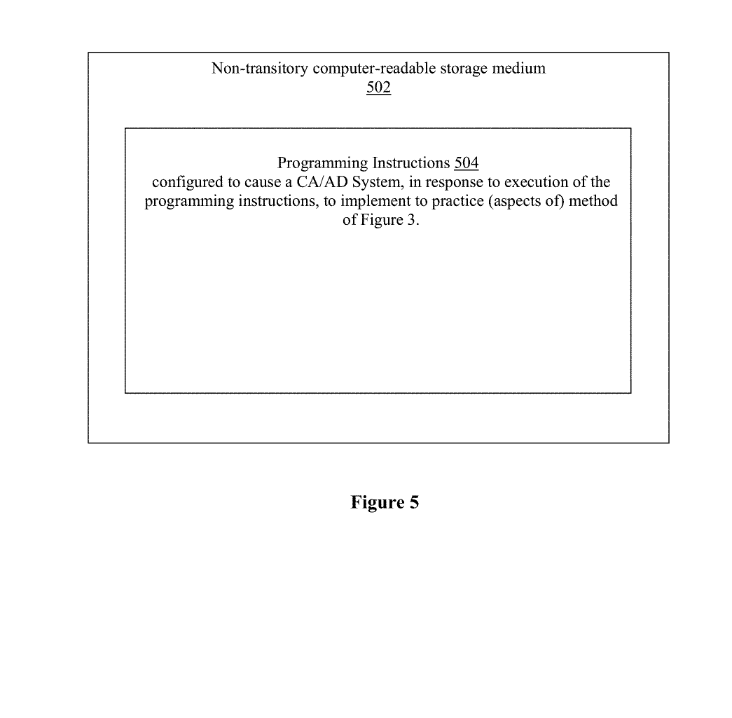

Referring now to FIG. 5, wherein an example non-transitory computer-readable storage medium having instructions configured to practice all or selected ones of the operations associated with CA/AD system 200, earlier described, in accordance with various embodiments, is shown. As illustrated, non-transitory computer-readable storage medium 502 may include the executable code of a number of programming instructions 504. Executable code of programming instructions 504 may be configured to enable a system, e.g., CA/AD system 200 or computer system 400, in response to execution of the executable code/programming instructions, to perform, e.g., various operations associated law enforcement assistance described with references to FIGS. 1-3. In alternate embodiments, executable code/programming instructions 504 may be disposed on multiple non-transitory computer-readable storage medium 502 instead. In still other embodiments, executable code/programming instructions 504 may be encoded in transitory computer readable medium, such as signals.

In embodiments, a processor may be packaged together with a computer-readable storage medium having some or all of executable code of programming instructions 504 configured to practice all or selected ones of the operations earlier described with references to FIG. 1-3. For one embodiment, a processor may be packaged together with such executable code 504 to form a System in Package (SiP). For one embodiment, a processor may be integrated on the same die with a computer-readable storage medium having such executable code 504. For one embodiment, a processor may be packaged together with a computer-readable storage medium having such executable code 504 to form a System on Chip (SoC). For at least one embodiment, the SoC may be utilized in, e.g., CA/AD system 200.

Thus, an improved method and apparatus for law enforcement assistance in the context of computer-aided or autonomous driving vehicles has been described. The approach may be especially helpful for law enforcement situations, such as Amber Alerts in the United States, where law enforcement related messages are issued to seek public assistance in locating persons and/or vehicles potentially associated with child abduction situations.

Example embodiments described include, but are not limited to,

Example 1 is an apparatus for computer-assisted or autonomous driving, comprising: a communication interface to receive a law enforcement related message having description of a vehicle of interest to a law enforcement agency; a sensor interface to receive sensor data associated with vehicles around a host vehicle on which the apparatus is disposed; and a law enforcement assistance unit coupled to the communication interface and the sensor interface to determine whether one of the vehicles around the host vehicle is the vehicle of interest, based at the least in part on the description of the vehicle of interest in the law enforcement related message and the received sensor data.

Example 2 is example 1, wherein the law enforcement assistance unit includes a law enforcement interaction component to process the received law enforcement related message to extract the description of the vehicle of interest to the law enforcement agency.

Example 3 is example 2, wherein the description of the vehicle of interest includes one or more of a license plate number of the vehicle of interest, a maker of the vehicle of interest, a model of the vehicle of interest, a year made of the vehicle of interest, or a color of the vehicle of interest.

Example 4 is example 3, wherein the sensor data associated with vehicles around the host vehicle includes images of the vehicles around the host vehicle, and the law enforcement assistance unit includes an analysis component to process the images to extract one or more of license plate numbers of the vehicles around the host vehicle, makers of the vehicles around the host vehicle, models of the vehicle around the host vehicle, years made of the vehicles around the host vehicle, or colors of the vehicles around the host vehicle.

Example 5 is example 4, wherein the analysis component is to further determine whether one of the vehicles around the host vehicle is the vehicle of interest, based on the license plate numbers of the vehicles around the host vehicle, the makers of the vehicles around the host vehicle, the models of the vehicle around the host vehicle, the years made of the vehicles around the host vehicle, or the colors of the vehicles around the host vehicle match the license plate number of the vehicle of interest, the maker of the vehicle of interest, the model of the vehicle of interest, the year made of the vehicle of interest, or the color of the vehicle of interest.

Example 6 is example 5, further comprising a database of reference images of vehicles of various makers, models, and years made, and the analysis component further uses the reference images in the database in determining whether one of the vehicles around the host vehicle is the vehicle of interest.

Example 7 is example 5, further comprising a database of reference license plates of various jurisdictions, and the analysis component further uses the reference license plates in the database in determining whether one of the vehicles around the host vehicle is the vehicle of interest.

Example 8 is example 4, further comprising a plurality of cameras to provide the images of the vehicles around the host vehicle.

Example 9 is example 2, wherein the law enforcement interaction component, on determination that one of the vehicles around the host vehicle is the vehicle of interest, is to further transmit a message to report the determination.

Example 10 is example 9, wherein the law enforcement related message further includes reporting information, and the law enforcement interaction component is to transmit the message to make the report in accordance with the reporting information.

Example 11 is example 9, wherein the law enforcement interaction component is to transmit a voice or text message to report the determination.

Example 12 is example 9, wherein the law enforcement interaction component is to include in the transmitted message a current location of the host vehicle, a date of the determination, or a time of the determination.

Example 13 is example 12, further comprising a global positioning system (GPS), wherein the current location of the host vehicle comprises a current GPS position of the host vehicle.

Example 14 is any one of examples 1-13, wherein the law enforcement related message is a public assistance request message of the law enforcement agency.

Example 15 is example 14, wherein the public assistance request message is an Amber Alert message.

Example 16 is a method for computer-assisted or autonomous driving, comprising: receiving, by a computer-assisted or autonomous driving (CA/AD) system of a semi-autonomous or autonomous driving (A/SA) vehicle, a law enforcement related message having description of a vehicle of interest to a law enforcement agency; receiving, by the CA/AD system, sensor data associated with vehicles around a host vehicle on which the CA/AD system is disposed; and determining, by the CA/AD system, whether one of the vehicles around the host vehicle is the vehicle of interest, based at the least in part on the description of the vehicle of interest in the law enforcement related message and the received sensor data.

Example 17 is example 16, further comprising transmitting, by the CA/AD system, a message to report a determination of one of the vehicles around the host vehicle is the vehicle of interest.

Example 18 is example 16, further comprising processing, by the CA/AD system, the received law enforcement related message to extract the description of the vehicle of interest to the law enforcement agency.

Example 19 is example 16, wherein the description of the vehicle of interest includes one or more of a license plate number of the vehicle of interest, a maker of the vehicle of interest, a model of the vehicle of interest, a year made of the vehicle of interest, or a color of the vehicle of interest.

Example 20 is example 19, wherein the sensor data associated with vehicles around the host vehicle includes images of the vehicles around the host vehicle, and the method further includes processing the images to extract one or more of license plate numbers of the vehicles around the host vehicle, makers of the vehicles around the host vehicle, models of the vehicle around the host vehicle, years made of the vehicles around the host vehicle, or colors of the vehicles around the host vehicle.

Example 21 is example 20, wherein determining comprises determining whether one of the vehicles around the host vehicle is the vehicle of interest, based on the license plate numbers of the vehicles around the host vehicle, the makers of the vehicles around the host vehicle, the models of the vehicle around the host vehicle, the years made of the vehicles around the host vehicle, or the colors of the vehicles around the host vehicle match the license plate number of the vehicle of interest, the maker of the vehicle of interest, the model of the vehicle of interest, the year made of the vehicle of interest, or the color of the vehicle of interest.

Example 22 is example 21, wherein determining further comprises using a plurality of reference images of vehicles of various makers, models, and years made.

Example 23 is example 21, wherein determining further comprises using a plurality of reference license plates of various jurisdictions.

Example 24 is example 17, wherein the law enforcement related message further includes reporting information, and transmitting comprises transmitting the message to make the report in accordance with the reporting information.

Example 25 is example 17, wherein transmitting comprises transmitting a voice or text message to report the determination.

Example 26 is example 17, wherein transmitting comprises transmitting a message that includes a current location of the host vehicle, a date of the determination, or a time of the determination.

Example 27 is example 26, wherein the current location of the host vehicle comprises a current GPS position of the host vehicle.

Example 28 is any one of example 16-27, wherein the law enforcement related message is a public assistance request message of the law enforcement agency.

Example 29 is example 28, wherein the public assistance request message is an Amber Alert message.

Example 30 is at least one computer readable media (CRM) comprising a plurality of instructions arranged to cause a computer-assisted or autonomous driving (CA/AD) system disposed in a semi-autonomous or autonomous driving (A/SA) vehicle, in response to execution of the instructions by the CA/AD system, to: receive a law enforcement related message having description of a vehicle of interest to a law enforcement agency; receive sensor data associated with vehicles around a host vehicle on which the apparatus is disposed; and determine whether one of the vehicles around the host vehicle is the vehicle of interest, based at the least in part on the description of the vehicle of interest in the law enforcement related message and the received sensor data.

Example 31 is example 30, wherein the CA/AD system is further caused to transmit a message to report a determination of one of the vehicles around the host vehicle is the vehicle of interest.

Example 32 is example 30, wherein the CA/AD system is further caused to process the received law enforcement related message to extract the description of the vehicle of interest to the law enforcement agency.

Example 33 is example 30, wherein the description of the vehicle of interest includes one or more of a license plate number of the vehicle of interest, a maker of the vehicle of interest, a model of the vehicle of interest, a year made of the vehicle of interest, or a color of the vehicle of interest.

Example 34 is example 33, wherein the sensor data associated with vehicles around the host vehicle includes images of the vehicles around the host vehicle, and wherein the CA/AD system is further caused to process the images to extract one or more of license plate numbers of the vehicles around the host vehicle, makers of the vehicles around the host vehicle, models of the vehicle around the host vehicle, years made of the vehicles around the host vehicle, or colors of the vehicles around the host vehicle.

Example 35 is example 34, wherein to determine comprises to determine whether one of the vehicles around the host vehicle is the vehicle of interest, based on the license plate numbers of the vehicles around the host vehicle, the makers of the vehicles around the host vehicle, the models of the vehicle around the host vehicle, the years made of the vehicles around the host vehicle, or the colors of the vehicles around the host vehicle match the license plate number of the vehicle of interest, the maker of the vehicle of interest, the model of the vehicle of interest, the year made of the vehicle of interest, or the color of the vehicle of interest.

Example 36 is example 35, wherein to determine further comprises to determine using a plurality of reference images of vehicles of various makers, models, and years made.

Example 37 is example 35, wherein to determine further comprises to determine using a plurality of reference license plates of various jurisdictions.

Example 38 is example 31, wherein the law enforcement related message further includes reporting information, and to transmit comprises to transmit the message to make the report in accordance with the reporting information.

Example 39 is example 31, wherein to transmit comprises to transmit a voice or text message to report the determination.

Example 40 is example 31, wherein to transmit comprises to transmit a message that includes a current location of the host vehicle, a date of the determination, or a time of the determination.

Example 41 is example 40, wherein the current location of the host vehicle comprises a current GPS position of the host vehicle.

Example 41 is any one of example 30-41, wherein the law enforcement related message is a public assistance request message of the law enforcement agency.

Example 43 is example 42, wherein the public assistance request message is an Amber Alert message.

Example 44 is an apparatus for computer-assisted or autonomous driving, comprising: first means, disposed in a semi-autonomous or autonomous driving (A/SA) vehicle, for receiving a law enforcement related message having description of a vehicle of interest to a law enforcement agency; second means, disposed in the A/SA vehicle, for receiving sensor data associated with vehicles around a host vehicle on which the apparatus is disposed; and third means, disposed in the A/SA vehicle, for determining whether one of the vehicles around the host vehicle is the vehicle of interest, based at least in part on the description of the vehicle of interest in the law enforcement related message and the received sensor data.

Example 45 is example 44, further comprising fourth means, disposed in the A/SA vehicle, for transmitting a message to report a determination of one of the vehicles around the host vehicle is the vehicle of interest.

Example 46 is example 44, further comprising fifth means for processing the received law enforcement related message to extract the description of the vehicle of interest to the law enforcement agency.

Example 47 is example 44, wherein the description of the vehicle of interest includes one or more of a license plate number of the vehicle of interest, a maker of the vehicle of interest, a model of the vehicle of interest, a year made of the vehicle of interest, or a color of the vehicle of interest.

Example 48 is example 47, wherein the sensor data associated with vehicles around the host vehicle includes images of the vehicles around the host vehicle, and the apparatus further includes fifth means for processing the images to extract one or more of license plate numbers of the vehicles around the host vehicle, makers of the vehicles around the host vehicle, models of the vehicle around the host vehicle, years made of the vehicles around the host vehicle, or colors of the vehicles around the host vehicle.

Example 49 is example 48, wherein said third means for determining comprises means for determining whether one of the vehicles around the host vehicle is the vehicle of interest, based on the license plate numbers of the vehicles around the host vehicle, the makers of the vehicles around the host vehicle, the models of the vehicle around the host vehicle, the years made of the vehicles around the host vehicle, or the colors of the vehicles around the host vehicle match the license plate number of the vehicle of interest, the maker of the vehicle of interest, the model of the vehicle of interest, the year made of the vehicle of interest, or the color of the vehicle of interest.

Example 50 is example 49, wherein said third means for determining further comprises means for using a plurality of reference images of vehicles of various makers, models, and years made.

Example 51 is example 49, wherein said third means for determining further comprises means for using a plurality of reference license plates of various jurisdictions.

Example 52 is example 44, wherein the law enforcement related message further includes reporting information, and said fourth means for transmitting comprises means for transmitting the message to make the report in accordance with the reporting information.

Example 53 is example 45, wherein said fourth means for transmitting comprises means for transmitting a voice or text message to report the determination.

Example 54 is example 45, wherein said fourth means for transmitting comprises means for transmitting a message that includes a current location of the host vehicle, a date of the determination, or a time of the determination.

Example 55 is example 54, wherein the current location of the host vehicle comprises a current GPS position of the host vehicle.

Example 56 is any one of examples 44-55, wherein the law enforcement related message is a public assistance request message of the law enforcement agency.

Example 57 is example 56, wherein the public assistance request message is an Amber Alert message.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. An apparatus for computer-assisted or autonomous driving (CA/AD), comprising:
a communication interface disposed in a non-law enforcement CA/AD vehicle to receive a law enforcement related message having description of a vehicle of interest to a law enforcement agency;
a sensor interface disposed in the non-law enforcement CA/AD vehicle to receive sensor data associated with vehicles around the non-law enforcement CA/AD vehicle;
a law enforcement assistance unit, disposed in the non-law enforcement CA/AD vehicle and coupled to the communication interface and the sensor interface, to determine whether one of the vehicles around the non-law enforcement CA/AD vehicle is the vehicle of interest, based at the least in part on the description of the vehicle of interest in the law enforcement related message and the received sensor data, and on determination that one of the vehicles around the non-law enforcement CA/AD vehicle is the vehicle of interest, transmit or cause to transmit a message to a remote recipient to directly or indirectly report the determination to the law enforcement agency.

2. The apparatus of claim 1, wherein the law enforcement assistance unit includes a law enforcement interaction component to process the received law enforcement related message to extract the description of the vehicle of interest to the law enforcement agency.

3. The apparatus of claim 2, wherein the description of the vehicle of interest includes one or more of a license plate number of the vehicle of interest, a maker of the vehicle of interest, a model of the vehicle of interest, a year made of the vehicle of interest, or a color of the vehicle of interest.

4. The apparatus of claim 3, wherein the sensor data associated with vehicles around the non-law enforcement CA/AD vehicle includes images of the vehicles around the non-law enforcement CA/AD vehicle, and the law enforcement assistance unit includes an analysis component to process the images to extract one or more of license plate numbers of the vehicles around the non-law enforcement CA/AD vehicle, makers of the vehicles around the non-law enforcement CA/AD vehicle, models of the vehicle around the non-law enforcement CA/AD vehicle, years made of the vehicles around the non-law enforcement CA/AD vehicle, or colors of the vehicles around the non-law enforcement CA/AD vehicle.

5. The apparatus of claim 4, wherein the analysis component is to further determine whether one of the vehicles around the non-law enforcement CA/AD vehicle is the vehicle of interest, based on the license plate numbers of the vehicles around the non-law enforcement CA/AD vehicle, the makers of the vehicles around the non-law enforcement CA/AD vehicle, the models of the vehicle around the non-law enforcement CA/AD vehicle, the years made of the vehicles around the non-law enforcement CA/AD vehicle, or the colors of the vehicles around the non-law enforcement CA/AD vehicle match the license plate number of the vehicle of interest, the maker of the vehicle of interest, the model of the vehicle of interest, the year made of the vehicle of interest, or the color of the vehicle of interest.

6. The apparatus of claim 5, further comprising a database of reference images of vehicles of various makers, models, and years made, and the analysis component further uses the reference images in the database in determining whether one of the vehicles around the non-law enforcement CA/AD vehicle is the vehicle of interest.

7. The apparatus of claim 5, further comprising a database of reference license plates of various jurisdictions, and the analysis component further uses the reference license plates in the database in determining whether one of the vehicles around the non-law enforcement CA/AD vehicle is the vehicle of interest.

8. The apparatus of claim 4, further comprising a plurality of cameras to provide the images of the vehicles around the non-law enforcement CA/AD vehicle.

9. The apparatus of claim 2, wherein the law enforcement interaction component, on determination that one of the vehicles around the non-law enforcement CA/AD vehicle is the vehicle of interest, is to further transmit a message to report the determination.

10. The apparatus of claim 9, wherein the law enforcement related message further includes reporting information, and the law enforcement interaction component is to transmit the message to make the report in accordance with the reporting information.

11. The apparatus of claim 9, wherein the law enforcement interaction component is to transmit a voice or text message to report the determination.

12. The apparatus of claim 9, wherein the law enforcement interaction component is to include in the transmitted message a current location of the CA/AD vehicle, a date of the determination, or a time of the determination.

13. The apparatus of claim 12, further comprising a global positioning system (GPS), wherein the current location of the non-law enforcement CA/AD vehicle comprises a current GPS position of the non-law enforcement CA/AD vehicle.

14. The apparatus of claim 1, wherein the law enforcement related message is a public assistance request message of the law enforcement agency.

15. The apparatus of claim 14, wherein the public assistance request message is an Amber Alert message.

16. A method for computer-assisted or autonomous driving, comprising:
receiving, by a computer-assisted or autonomous driving (CA/AD) system of a non-law enforcement CA/AD vehicle, a law enforcement related message having description of a vehicle of interest to a law enforcement agency;
receiving, by the CA/AD system, sensor data associated with vehicles around the non-law enforcement CA/AD vehicle on which the CA/AD system is disposed;
determining, by the CA/AD system, whether one of the vehicles around the non-law enforcement CA/AD vehicle is the vehicle of interest, based at the least in part on the description of the vehicle of interest in the law enforcement related message and the received sensor data; and
transmitting, by the CA/AD system, a message to a remote recipient to directly or indirectly report a determination of one of the vehicles around the non-law enforcement CA/AD vehicle is the vehicle of interest to the law enforcement agency.

17. The method of claim 16, further comprising processing, by the CA/AD system, the received law enforcement related message to extract the description of the vehicle of interest to the law enforcement agency.

18. At least one non-transitory computer readable media (CRM) comprising a plurality of instructions arranged to cause a computer-assisted or autonomous driving (CA/AD) system disposed in a non-law enforcement CA/AD vehicle, in response to execution of the instructions by the CA/AD system, to:
receive a law enforcement related message having description of a vehicle of interest to a law enforcement agency;
receive sensor data associated with vehicles around the non-law enforcement CA/AD vehicle on which the apparatus is disposed;
determine whether one of the vehicles around the non-law enforcement CA/AD vehicle is the vehicle of interest, based at the least in part on the description of the vehicle of interest in the law enforcement related message and the received sensor data: and
transmit a message to a remote recipient outside the non-law enforcement CA/AD vehicle to directly or indirectly report a determination of one of the vehicles around the non-law enforcement CA/AD vehicle is the vehicle of interest to the law enforcement agency.

19. The CRM of claim 18, wherein the law enforcement related message is a public assistance request message of the law enforcement agency.

20. The CRM of claim 18, wherein the CA/AD system is further caused to process the received law enforcement related message to extract the description of the vehicle of interest to the law enforcement agency.

21. The CRM of claim 18, wherein the description of the vehicle of interest includes one or more of a license plate number of the vehicle of interest, a maker of the vehicle of interest, a model of the vehicle of interest, a year made of the vehicle of interest, or a color of the vehicle of interest.

22. The CRM of claim 21, wherein the sensor data associated with vehicles around the non-law enforcement CA/AD vehicle includes images of the vehicles around the non-law enforcement CA/AD vehicle, and wherein the CA/AD system is further caused to process the images to extract one or more of license plate numbers of the vehicles around the non-law enforcement CA/AD vehicle, makers of the vehicles around the non-law enforcement CA/AD vehicle, models of the vehicle around the non-law enforcement CA/AD vehicle, years made of the vehicles around the non-law enforcement CA/AD vehicle, or colors of the vehicles around the non-law enforcement CA/AD vehicle.

23. The CRM of claim 22, wherein to determine comprises to determine whether one of the vehicles around the non-law enforcement CA/AD vehicle is the vehicle of interest, based on the license plate numbers of the vehicles around the non-law enforcement CA/AD vehicle, the makers of the vehicles around the non-law enforcement CA/AD vehicle, the models of the vehicle around the non-law enforcement CA/AD vehicle, the years made of the vehicles around the non-law enforcement CA/AD vehicle, or the colors of the vehicles around the non-law enforcement CA/AD vehicle match the license plate number of the vehicle of interest, the maker of the vehicle of interest, the model of the vehicle of interest, the year made of the vehicle of interest, or the color of the vehicle of interest.

24. The CRM of claim 18, wherein to transmit comprises to transmit a voice or text message to report the determination.

25. The CRM of claim 18, wherein to transmit comprises to transmit a message that includes a current location of the non-law enforcement CA/AD vehicle, a date of the determination, or a time of the determination.
